(19) United States
(12) Patent Application Publication
(10) Pub. No.: US 2008/0184203 A1
(43) Pub. Date: Jul. 31, 2008

(54) Predicting trustworthiness for component software

(75) Inventor: Zheng Yan, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/515,352

(22) Filed: Sep. 1, 2006

(51) Int. Cl. G06F 9/44

(52) U.S. Cl. 717/126

(57) ABSTRACT

This invention relates to a method, an apparatus and a computer program product for determining whether a set of specifications related to a software component can be satisfied by a system, wherein said set of specifications comprises at least one specification, and wherein at least one specification of said at least one specification is one out of a resource requirement and a performance specification; and for initiating a function provided by the system if said set of specifications can be satisfied, wherein said function is related to said software component.

### FIELD OF THE INVENTION

This invention relates to a method, an apparatus, a system and a computer program product related to a system for software components.

### BACKGROUND OF THE INVENTION

The growing importance of software, in particular in the domain of mobile systems, introduces special requirements on trust due to the nature of applications they provide. This holds in particular when the software is component based and varies due to components joining and leaving the system. In general, mobile software design must support a product-line approach to system development. This normally implies that the system software consists of a number of software components that are combined to provide user features. Common software components can be effectively shared by applications in order to reduce development time and improve runtime efficiency. Each component contains functionality executed and used by application, they consume resources, and they can have various informational models attached. A common feature of mobile devices with component software is to allow addition of software components after deployment time, which creates the need for both download time and runtime trust management inside the devices.

In general, a software component is signed and verified by the device for downloading. If the signature and integrity verification is successful, the software component will be treated as trusted, otherwise, the device could discard the component or put it into a secure wrapper in order to control its access to the system resources, e.g. a file system. The focus on the security aspect of trust in the existing solution tends to assume that the other non-functional requirements, such as availability and reliability, have already been addressed.

Further methods have been proposed to ensure the quality of component services at runtime and to protect the users of the component software at runtime.

These solutions show the drawback, that a service of a software component might decrease the systems performance after being downloaded and/or executed, and thus may influence the performance of other services running on said system considerably leading to a decreased whole system's trust.

### SUMMARY OF THE INVENTION

In view of the above-mentioned problem, it is, inter alia, an object of the present invention to provide a method, a computer program product, an apparatus and a system for increasing trustworthiness of a system for software components.

It is proposed a method which comprises determining whether a set of specifications related to a software component can be satisfied by a system, wherein said set of specifications comprises at least one specification, and wherein at least one specification of said at least one specification is one out of a resource requirement and a performance specification, and initiating a function provided by the system if said set of specifications can be satisfied, wherein said function is related to said software component.

Said system may be a component software system suitable to load at least one software component, wherein at least one of said at least one software component may comprise at least one service, wherein said service may be a unit of software instantiation that is contained in a software component and can be used by an application of said software system. Thus, said component software system is configured to execute at least one service of at least one software component.

For instance, said function may be a download function for downloading said software component, or it may be an executing function for executing said software component, e.g. executing a service of said software component, but said function may also be any other further function relating to the software component. Furthermore, said function may represent a plurality of functions.

In case that said function is a download function, it is assumed that the software component is not downloaded into the system when said determining whether a set of specifications related to a software component can be satisfied by a system is started, and in case that said function is said executing function then said software component is already loaded into the system.

Said set of specifications may comprise any kind of specifications related to said software component, e.g. resource requirements like requirements on memory, and/or CPU, and/or bus, and/or net, etc. . . . and/or performance specifications like specifications on response time, and/or uptime, and/or mean time of failure and any other performance specifications. Said set of specifications may comprise only one specification, or any composition of different specifications. Said set of specifications may comprise further specifications like trust priority specifications or any other specifications related to the software system, and, for instance, also related to the system.

Said performance specifications may describe the performance that said software component provides if said resource specifications can be satisfied, and said performance specifications may be used by the system to check if a software component can satisfy the system's expectation. For instance, said performance specifications may be used to compare different software components with the same functionality, e.g. provided by different vendors, so that the best component for the system can by predicted based on said performance specifications.

Furthermore, said set of specifications may depend on the function to be initiated. E.g., in case that said function is executing a service of said software component, said set of specifications may be associated with specifications related to said service to said system when being executed, wherein also information of the system, like resource requirements and/or performance specifications of running services of said system, may be incorporated by said set of specifications. Further, said software component may comprise a profile for specification information and/or information for generating said specifications.

Said determining whether a set of software component specifications related to a software component can be satisfied by a system before initiating said function related to said software component may allow to check whether said software component could cause a problem to the system, e.g. a resource problem and/or a performance problem, e.g. when said software component is executed and it has to share resources of the system with other applications running on the system, so that said function related to that software component may only be initiated, when it is ensured that the software component can cooperate well with the system, e.g. with respect to performance and/or quality.

Thus, according to the present invention, a trustworthiness prediction about the software component in said system can be performed before a function related to said software component is initiated, and depending on said trustworthiness prediction, said function related to said software component is initiated, wherein said function may be downloading said software component and/or executing said software component, e.g. executing a service of said software component, or any further function related to a software component. Hence, the method allows improving predictability on potential trust conflicts on non-functional properties such as resource availability and/or system reliability.

According to an embodiment of the present invention, in case that at least one of said at least one specification can not be satisfied by the system said method further comprises raising a warning, and initiating or not initiating said at least one function provided by the system depending on a user's decision.

Thus, in case that at least one of said set of specifications can not be satisfied by the system, a user may be informed by raising at least one warning, and the user may be asked whether to proceed with performing said function related to the software component though not all specifications of said set of specifications can be satisfied, or not to proceed with initiating said function related to the software component. Depending on the user's decision, the method will not initiate said function or initiate said function. For instance, each specification of said set of specifications is verified sequentially, and if verifying is not positive, then the user may be warned and asked whether to proceed with verifying the successive specification of said set of specifications or to cancel the verification and not to start said function related to the software component. If the user indicated to proceed verification to any of the specifications verified not positive, then said function related to the software component will performed.

According to an embodiment of the present invention, said function represents one of downloading said software component into said system and executing said software component by said system.

According to an embodiment of the present invention, said software component is associated with a component profile indicating specifications suited to be used to determine said set of specifications.

For instance, said component profile may be described using XML or any other language. Further, said component profile may be a trust model profile of the component.

Said component profile may contain concrete specifications of said software component, like requirements on resources, and/or specifications on performance, and/or trust priority levels, but said component profile may further comprise compositions rules for composing specifications of said software component to other software components, which for example may be executed on said system and which have to share resources with said software component.

Said component profile may be bound together with a software certificate and/or permission profile, thus the invention is compatible with existing trust/security verification technology. For instance, a new profile may comprise both the security verification and said component profile indicating specifications.

Thus, said component profile may be used to extract and/or to generate at least one specification for said set of specifications.

Furthermore said component profile indicating specifications may be adaptive so that at least one specification indicated by said component profile may be adjusted, e.g. based on execution results of said system.

According to an embodiment of the present invention, said software component contains at least one service, and wherein said profile comprises a service profile for at least one of said at least one service, respectively, said service profile comprising at least one service specification of said service, wherein at least one of said at least one service specification is at least one out of: at least one resource requirement, at least one performance specification, and at least one trust level specification.

Furthermore, said executing said software component may be executing at least one service of said software component.

The system may be a component software system composed of a number of entities. These entities may be any parties that are involved into or related to the component software system. They can be related with each other in order to provide some services or functionalities. Theses entities may include a system user, a service, a component and/or compositions of components, an application, a sub-system, which may be a group of system entities) and a system, etc. An application may be a software entity that provides a set of function to a user, and a component may be a unit of trading that may contain multiple services. Said service may represent a unit of software contained in the corresponding software component, wherein the system is configured to execute services. Said system may be a combination of a platform, a set of components, a runtime environment and a set of applications that may provide a user with a set of functions. A platform may provide access to an underlying hardware.

Said at least one resource requirement may define requirements on different resources like requirements on memory, and/or CPU, and/or bus, and/or net, etc. Said at least one performance specification may specify the performance achieved if the required resources can be fulfilled, wherein said performance specification can be described by an ‘attribute’ and its ‘value’. For example, said attribute may be at least one out of response time, uptime, mean time of failure or any other performance attribute of a service. Said at least one trust level specification may indicate at least one trust level specification, e.g. a trust priority level, of said service.

Said service profile may further be provided with a unique ID and/or a service description, wherein said service description describes the service's dependencies for execution. Further, said service profile may indicate a trust level specification, e.g. a trust priority level, of said service.

Said trust priority levels may be used to arrange resources to the services, e.g. in case of conflict for resource management and assignment with respect to other services, e.g. at least one further service of the same software component or any other component service. For instance, a service with higher trust priority level will have higher priority to get resource arrangement if there is any conflict among the services. This arrangement of resources based on said trust priority levels may be performed before said function is initiated.

For instance, said component profile comprises a service profile for each service of said component profile. Furthermore, said service profile may comprise at least one resource requirement and at least one performance specification.

Thus, said component profile comprising said at least one service profile may be used to extract at least one specification from said set of specifications, which may depend on the function to be performed.

Furthermore said service profile may be adaptive so that for instance at least one specification may be adjusted, e.g. based on execution results of said system.

According to an embodiment of the present invention, said method further comprises locating resources for at least one service in said system based on at least one trust level specification in at least one service profile.

Said locating resources based on at least one service profile may be applied to services causing conflict for resource management and resource assignment to these services for said system.

For instance, before initiating said function related to the software component, wherein said function may be executing a service of said software component, resources required by at least one service of said software component and/or to at least one further service related to the system are arranged based on at least one trust level specification. E.g., services running on said system may also comprise a service profile corresponding to said service profile mentioned above, which can be used to extract the trust level specifications of said running services. For instance, the service with higher trust level specification will have higher priority to get resource arrangement if there is any conflict among the services.

According to an embodiment of the present invention, said service profile comprises at least one composition rule for composing at least one service specification of said service profile with at least one corresponding specification with at least one service specification of at least one different service, and said method further comprises composing at least one service specification of at least one of said at least one service profile of said software component with at least one further service specification into at least one composed specification associated with said set of specifications.

Said at least one composition rule may specify composition policies for composing resource consumption, and/or performance, and/or trust priority level in different situations. Said at least one composition rule may be different for different specifications and scenarios.

Any service specification of said at least one service profile of said software component can be composed with any corresponding service specification of a further service of said software component and/or with any corresponding service specification of at least one different software component, wherein said at least one different software component may be in said system.

For instance, at least one of said at least one composition rule may be suited to compose at least one resource requirement of at least one service of said software component with at least one resource requirement of at least one further service of said software component and/or with at least one resource requirement of at least one other component service in the system, e.g. in order to generate at least one composed resource requirement suited for said set of specifications, wherein said composing may further be based on at least one service description of said at least one service of said software component and/or on at least one service description of said at least one other component service and/or on at least one service description of said at least one further service.

Further, at least one of said at least one composition rule may be suited to compose at least one performance specification of at least one service of said software component with at least one performance specification of at least one further service of said software component and/or with at least one performance specification of at least one other component service in the system, e.g. in order to generate at least one composed performance specification suited for said set of specifications, wherein said composing may further be based on at least one service description of said at least one service of said software component and/or on at least one service description of said at least one other component service and/or on at least one service description of said at least one further service.

For instance, at least one of said at least one composition rule may be suited to compose at least one trust level specification of at least one service of said software component with at least one trust level specification of at least one further service of said software component and/or with at least one trust level specification of at least one other component service in the system, e.g. in order to generate at least one composed trust level specification suited for said set of specifications, wherein said composing may further be based on at least one service description of said at least one service of said software component and/or on at least one service description of said at least one other component service and/or on at least one service description of said at least one further service.

Further, for instance, said trust priority level may be used to compose performance specifications, because a system might arrange resources to the services based on trust priority levels. For instance, a service with higher trust priority level will have higher priority to get resource arrangement if there is any conflict among the services. Furthermore, said trust priority level may be used to be composed to other trust priority levels of other services.

According to an embodiment of the present invention, said method further comprises extracting at least one service specification of at least one of said at least one service profile from said software component into said set of specifications.

Said extracting at least one service specification from at least one of said at least one service profile of said software component into said set of specifications may be combined with said composing at least one service specification of said software component with at least one further service specification into at least one composed specification mentioned above, so that said set of specifications may comprise at least one extracted specification and/or at least one composed specification.

According to an embodiment of the present invention, said function is downloading said software component into said system, and said set of specifications comprises a first subset of specifications, wherein said first subset of specifications comprises at least one performance specification of at least one service of said software component extracted from said at least one service profile.

Thus, before said software component is downloaded into said system, it can be verified whether the system provides the performance offered by said software component, wherein the performance specification of one service, of a variety of services or of all services may be verified.

For instance, if at least one specification of said set first subset of specifications can not be satisfied, then a warning may be raised and a user may be asked to decide whether to start the download or not to start the download.

Furthermore, said set of specifications may contain at least one further specification, e.g. at least one further subset of specifications. In case of at least two subsets of specifications, each of said subsets may be verified sequentially, and if verification of a subset is not positive, a warning may be raised and a user may be asked to decide whether to ignore said not positive verification and proceed with the succeeding subset or to stop said verifying and not starting the download. This also holds for the following embodiments.

According to an embodiment of the present invention, said set of specifications comprises a second subset of specifications, wherein said second subset of specifications comprises at least one resource requirement of at least one service of said software component extracted from said at least one service profile.

Thus, before said software component is downloaded into said system, it can be verified whether the system provides resources for said software component, wherein the resource requirement of one service, of a variety of services or of all services may be verified.

Thus, at first, performance specifications are verified associated with the first subset of specifications, and then resource requirements are verified associated with the second subset of specifications. Alternatively, the second subset of specifications may be verified first followed by the first subset of specifications.

Furthermore, the set of specifications may also exclusively comprise said second subset of specifications, i.e. not comprising said first subset of specifications.

According to an embodiment of the present invention, said set of specifications comprises a second subset of specifications, said method further comprising composing at least one resource requirement of at least one of said at least one service profile of said software component with at least one resource requirement of at least one service of said software component and/or with at least one service of at least one further software component running on said system into at least one composed resource requirement associated with said second subset of specifications.

For instance, at least one of said at least one composition rule of said at least one of said at least one service profile may be used to compose said at least one composed resource requirement, wherein said composing may further be based on at least one composition rule of said at least one service of said at least one further software component and/or of said at least one further service, and wherein said composing may further be based on at least one service description of said at least one of said at least one service of said software component and/or at least one service description of said at least one service of said at least one other component system and/or at least one service description of said at least one further service.

Thus, for instance, by means of the second subset of specifications the resource requirements of services running on the system and at least one service of said software component to be downloaded can be composed and it can be verified whether the system provides sufficient resources for said services.

According to an embodiment of the present invention, said function represents executing a first service of said software component in said system, and wherein said set of specifications comprises a first subset of specifications, said method further comprising composing at least one performance specification of said first service with at least one performance specification of at least one further service of said software component and/or with at least one service of at least one further software component running on said system into at least one composed performance specification associated with said first subset of specifications.

Thus, before said first service is executed by said system, it can be verified whether the system provides sufficient performance for said first service of said software component by incorporating the performance specifications of services running on the system.

For instance, at least one composition rule of said service profile of said first service may be used to compose said at least one composed performance specification, wherein said composing may further be based on at least one composition rule of said at least one service of said at least one further software component and/or on at least one composition rule of said at least one further service, and wherein said composing may further be based on a service description of said first service and/or on at least one service description of said at least one service of at least one further software component running on said system and/or at least one service description of said at least one further service.

Furthermore, before composing said at least one composed performance specification, service profiles of said at least one service of at least one further software component running on said system and the service profile of said first service may be extracted and/or service profiles of said at least one further service may be extracted.

Furthermore, the method may comprise determining whether said first service can be executed on said system before starting verifying said set of specifications, and stopping said verifying and stopping executing said first service if the system is not suited to execute the first service.

According to an embodiment of the present invention, said set of specifications comprises a second subset of specifications, said method further comprising composing at least one resource requirement of said first service with at least one resource requirement of at least one further service of said software component and/or with at least one resource requirement of at least one further software component running on said system into at least one composed resource requirement associated with said second subset of specifications.

Thus, before said first service is executed by said system, it can be verified whether the system provides sufficient resources for said first service of said software component by incorporating the resource requirements of services running on the system.

For instance, at least one composition rule of a service profile of said first service may be used to compose said at least one composed resource requirement, wherein said composing may further be based on at least one composition rule of said at least one service of said at least one further software component and/or on at least one composition rule of said at least one further service, and wherein said composing may further be based on a service description of said first service and/or at least one service description of said at least one service of said at least one further component and/or at least one service description of said at least one further service.

According to an embodiment of the present invention, said method further comprises, prior to said determining whether said set of specifications related to said software component can be satisfied, verifying whether said first service can be executed on said system based on the service description of said service, and stopping performing said first service when said first service can not be executed.

According to an embodiment of the present invention, at least one of said at least one specification of at least one service profile can be updated.

Thus, for instance resource requirements and/or performance specifications and/or trust priority level specifications and/or other specifications of at least one service can be updated based on the real resource consumption and the performance of the system, e.g. based on the system's real execution results.

According to an embodiment of the present invention, said method further comprises verifying the integrity of said component profile.

Any integrity verification method may be used for this integrity check. If integrity is not given, a warning may be raised and depending on a user's decision the method may stop said determining whether a set of specifications related to a software component can be satisfied by a system and does not initiate said function or the method may proceed as proposed.

Moreover, an apparatus is proposed, which comprises a processing component configured to determine whether a set of specifications related to a software component can be satisfied by a system, wherein said set of specifications comprises at least one specification, and wherein at least one specification of said at least one specification is one out of a resource requirement and a performance specification. The processing component is further configured to initiate a function provided by the system if said set of specifications can be satisfied, wherein said function is related to said software component.

The processing component may be implemented in hardware and/or software. The apparatus could be realized for example in the form of a chip or in the form of a more comprehensive device, etc.

Moreover, a system is proposed, which comprises the proposed apparatus and which is configured to perform said function related to said software component.

For instance, this system may be a component software system as mentioned above. Furthermore, said system may be integrated in a mobile phone or any other electronic device using a software system.

Finally, a computer program product is proposed, in which a program code is stored in a computer readable medium. The program code realizes the proposed method when executed by a processor. Said program code may realize any of the above mentioned embodiments of the present invention related to the proposed method.

The computer program product could be for example a separate memory device, or a memory that is to be integrated in an electronic device.

The invention is to be understood to cover such a computer program code also independently from a computer program product and a computer readable medium.

Furthermore, the explanations mentioned above with respect to the method and the embodiments thereof also hold for the proposed apparatus, the proposed system, and the proposed computer program product.

Other objects and features of the present invention will become apparent from the following detailed description in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

In the figures show:

FIG. 1a: a schematic flow chart illustrating a first exemplary method according to the present invention;

FIG. 1b: a schematic flow chart illustrating a second exemplary method according to the present invention;

FIG. 2: a schematic block diagram of an exemplary system suited for the present invention;

FIG. 3: an exemplary software architecture of a system suited for the present invention;

FIG. 4: an exemplary data structure for a component profile according to the present invention;

FIG. 5: a schematic flow chart illustrating a third exemplary method according to the present invention;

FIG. 6: a schematic flow chart illustrating a fourth exemplary method according to the present invention; and

FIG. 7: a schematic block diagram of an apparatus according to the present invention.

### DETAILED DESCRIPTION OF THE INVENTION

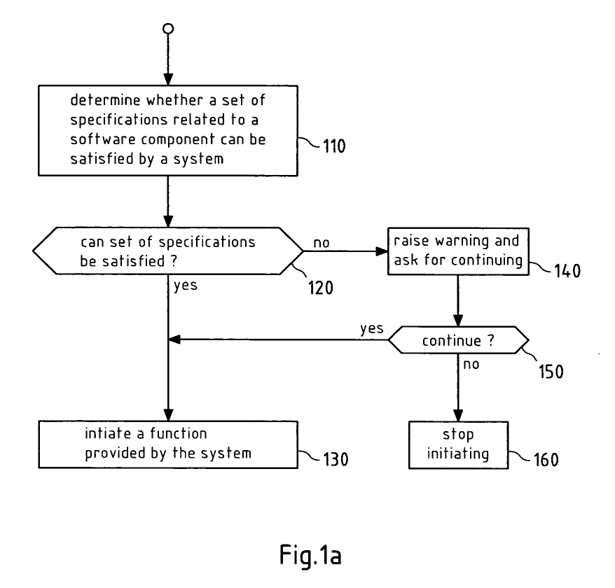

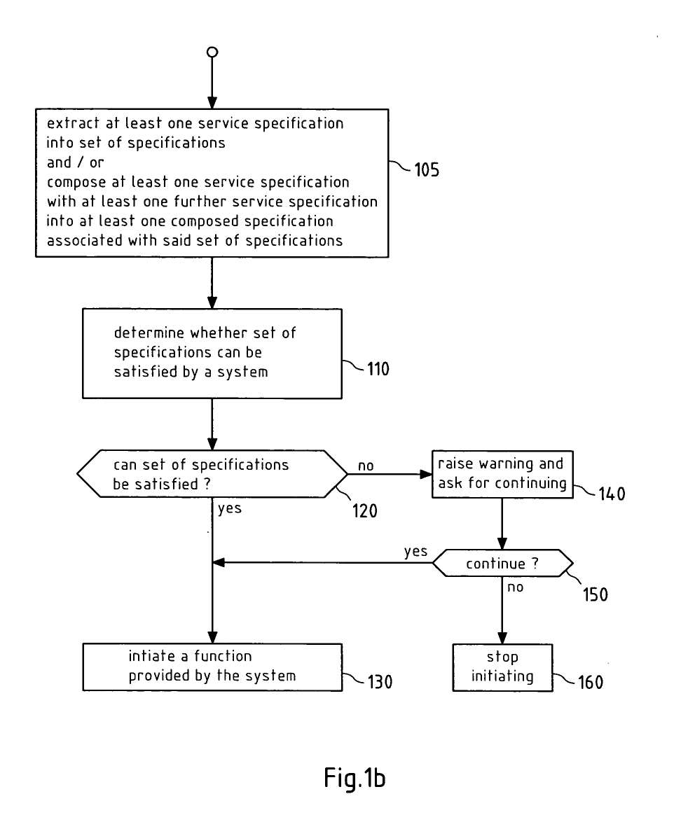

FIG. 1a depicts a schematic flow chart of a first exemplary method in accordance with the present invention.

This first exemplary method comprises determining whether a set of specifications related to a software component can be satisfied by a system (step 110), and if said set of specifications can be satisfied, which may be checked in step 120, then a function provided by a system is initiated (step 130).

Said set of specifications comprises at least one specification, wherein at least one specification of said at least one specification is one out of a resource requirement and a performance specification. Said set of specifications may comprise any further kind of specifications, e.g. trust level specifications or any other specifications related to the software component.

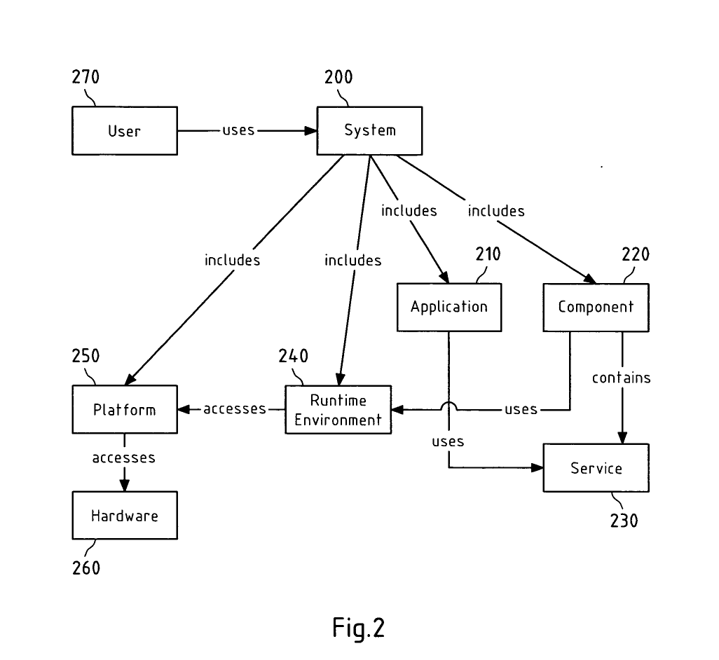

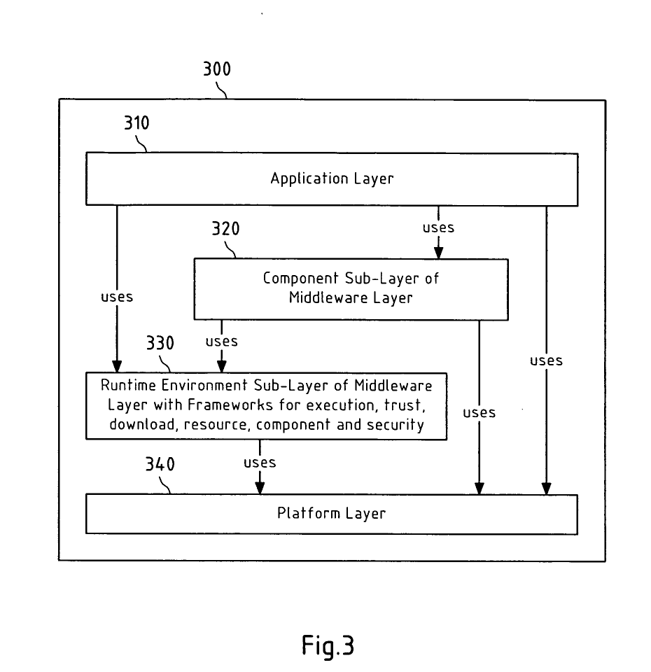

Said system may be a component software system suitable to load at least one software component, wherein at least one of said at least one software component may comprise at least one service, wherein said service may be a unit of software instantiation that is contained in a software component and can be used by an application of said software system. Thus, said component software system is configured to execute at least one service of at least one software component. More details about exemplary realisations of this system are explained in the sequel with respect to FIGS. 2 and 3.

For instance, said function may be a download function for downloading said software, or it may be an executing function for executing said software component, e.g. executing a service of said software component, but said function may also be any other further function relating to the software component. Furthermore, said function may be a representative for a plurality of functions.

Said set of specifications may comprise any kind of specifications and/or requirements of said software component to said system, e.g. resource requirements like requirements on memory, and/or CPU, and/or bus, and/or net, etc., and/or performance specifications like specifications on response time, and/or uptime, and/or mean time of failure and others performance specifications. Said set of specifications may comprise only one specification, or any composition of different specifications.

Furthermore, said set of specifications may depend on the function to be initiated. E.g., in case that said function is executing a service of said software component, said set of specifications may be associated with specifications of said service to said system when being executed. Further, said software component may comprise a profile for specification information and/or information for generating said specifications.

Said determining whether a set of software component specifications related to a software component can be satisfied by a system (step 110) before initiating said function related to said software component (step 130) may allow checking whether said software component could cause a problem to the system, e.g. a resource problem and/or a performance problem, for instance when said software component is executed and it has to share resources of the system with other applications running on the system. If it is detected that said set of specifications can be satisfied (step 120), then said function is initiated (step 130), otherwise a warning may be raised to a user and the user may be asked to decide whether to continue with initiating the function (step 140), and depending on the user's decision (step 150), the function is initiated (step 130) or it is not initiated (step 160). Said raising a warning and asking a user for continuing may be optional, so that when it is determined that said set of specifications can not be satisfied (steps 110, 120), then initiating said function may also be stopped without asking a user for continuing, i.e. that steps 140 and 150 are optional. For example, only a warning may be raised and the function is not initiated.

Thus, according to the first exemplary method depicted in FIG. 1a, a trustworthiness prediction about the software component in said system can be performed before a function related to said software component is initiated, and depending on said trustworthiness prediction, said function related to said software component is initiated, wherein said function may be downloading said software component and/or executing said software component, e.g. executing a service of said software component. Hence, the method allows improving predictability on potential trust conflicts on non-functional properties such as resource availability and/or system reliability.

FIG. 2 shows a schematic block diagram of an exemplary system suited for the present invention, wherein this system 200 represents a component software system 200 composed of a number of entities. These entities may be any parties that are involved into or related to the component software system. They can be related with each other in order to provide some services or functionalities. Theses entities may include a system user 270, at least one service 230, a component 220 and/or compositions of components 220, at least one application 210, and a sub-system, which may be a group of system entities (not shown). An application 210 may be a software entity that uses services and provides a set of function to a user 270, and a component 220 may be a unit of trading that may contain multiple services 230. Said service 230 may represent a unit of software contained in the corresponding software component 220, wherein the system 200 is configured to execute services 230. Said system 200 may be a combination of a platform 250, a set of components 220, a runtime environment 240 and a set of applications 230 that may provide a user 270 with a set of functions. A platform 250 may provide access to an underlying hardware 260.

The system 200 depicted in FIG. 2 is configured to perform said function which may be initiated according to the present invention.

FIG. 3 shows an exemplary software architecture 300 of a system suited for the present invention, wherein this system may be the exemplary component software system 200 depicted in FIG. 2.

The software architecture 300 of said component software system 200 may consist of layered development architecture with 3 layers, wherein an application layer 310 may provide features to a user, and wherein a component-based middleware layer 320, 330 may provide functionality to applications, and wherein a platform layer 340 may provide access to lower-level hardware. The middleware layer 320, 330 may be divided into two development layers: a component sub-layer 320 that contains a number of executable components and a runtime environment (RE) sub-layer 330 that supports component development and execution. Component runtime supporting frameworks may also exist at the runtime sub-layer. These frameworks provide functionalities for supporting component execution and for managing components.

For instance, the method according to present invention for determining whether a set of specifications related to a software component can be satisfied by the system may be implemented by a trust management framework at the RE sub-layer 330.

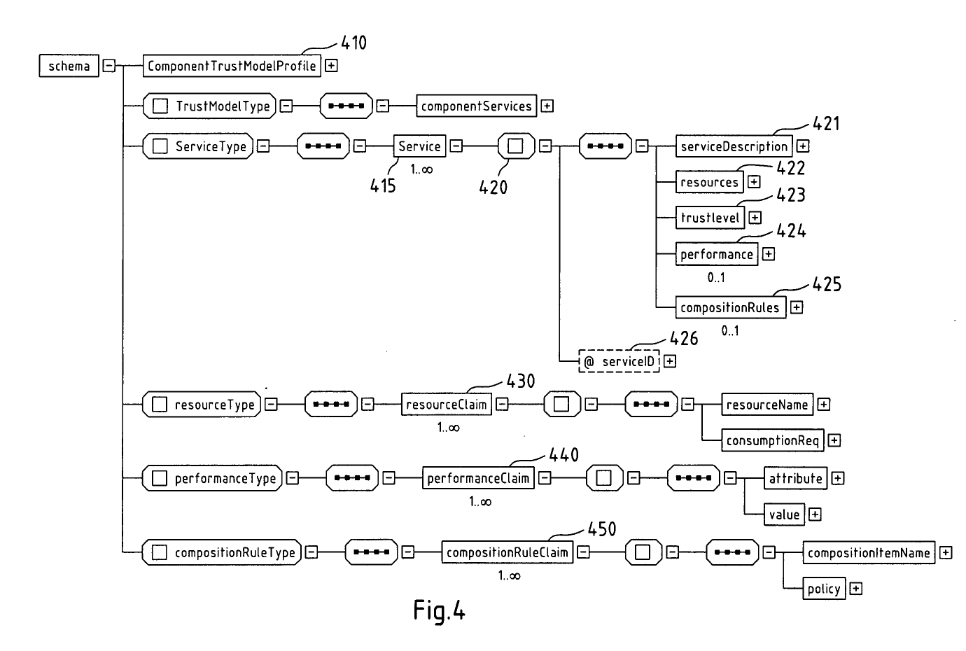

FIG. 4 depicts an exemplary data structure of a component profile which is associated with a software component, wherein this component profile indicates specifications suited to be used to determine said set of specifications.

Said component profile may represent a trust model profile 410 of the software component, as depicted in FIG. 4.

The trust model profile 410 contains a service profile 420 for each service 415 provided by a component, wherein said service profiles 420 comprises service specifications. Said service profile 420 may have a unique ID 426 and/or a description 421 attached, wherein the description 421 describes the service's dependencies for execution. Furthermore, said service profile 420 may comprise resource requirements 422, 430 on different resources, e.g. memory, CPU, bus, and net), and said service profile 420 may comprise performance specifications 424, 440 which may define the performance achieved if the required resources can be fulfilled. The performance may be described by an ‘attribute’ and its ‘value’, wherein examples for the attributes are response time, uptime, mean time of failure, etc. Furthermore, a service profile 420 may indicate a trust priority level 423 and composition rules 425 for composing the above items from different service profiles together.

Said composition rule 425 may specify composition policies for composing resource consumption, and/or performance, and/or trust priority level in different situations. Said composition rule may be different for different specifications and scenarios.

For instance, at least one of said at least one composition rule 425 may be used to compose at least one resource requirement 422, 430 of at least one service 415 of said software component with at least one resource requirement 422, 430 of at least one further service of said software component and/or with at least one resource requirement 422, 430 of at least one other component service in the system 200, e.g. in order to generate at least one composed resource requirement suited for said set of specifications, wherein said composing may further be based on at least one service description 421 of said at least one service 415 of said software component and/or on at least one service description 415 of said at least one other component service and/or on at least one service description 415 of said at least one further service.

Further, at least one of said at least one composition rule 425 may be suited to compose at least one performance specification 424, 440 of at least one service 415 of said software component with at least one performance specification 424, 440 of at least one further service of said software component and/or with at least one performance specification 424, 440 of at least one other component service in the system, e.g. in order to generate at least one composed performance specification suited for said set of specifications, wherein said composing may further be based on at least one service description 421 of said at least one service 415 of said software component and/or on at least one service description 421 of said at least one other component service and/or on at least one service description 421 of said at least one further service.

For instance, at least one of at said at least one composition 425 rule may be suited to compose at least one trust level specification 423 of at least one service 415 of said software component with at least one trust level specification 423 of at least one further service of said software component and/or with at least one trust level specification 423 of at least one other component service in the system, e.g. in order to generate at least one composed trust level specification suited for said set of specifications, wherein said composing may further be based on at least one service description 421 of said at least one service 415 of said software component and/or on at least one service description 421 of said at least one other component service and/or on at least one service description 421 of said at least one further service.

For instance, an exemplary composition rule may be a rule having the rule description “select maximum value” for composing a number of trust priority levels, bus speed, and net speed, or another exemplary composition rule may be a rule with rule description “sum of addition” for composing a number of memory request and CPU request, or another exemplary composition rule may be a rule with rule description “select minimum” value for composing a number of performance, such as net speed. Said exemplary composition rules may vary on the services, the system, and other aspects.

For instance, an example XML schema for a component profile could be realised as follows:

<?xml version=“1.0” encoding=“UTF-8”?>
<xs:schema xmlns:xs=“http://www.w3.org/2001/XMLSchema”>

<xs:element name=“ComponentTrustModelProfile”

type=“TrustModelType”/>

<xs:complexType name=“TrustModelType”>

<xs:sequence>

<xs:element name=“componentServices”

type=“ServiceType”/>

</xs:sequence>

</xs:complexType>
<xs:complexType name=“ServiceType”>

<xs:sequence>

<xs:element name=“Service”

maxOccurs=“unbounded”>

<xs:complexType>

<xs:sequence>

<xs:element

name=“serviceDescription” type=“xs:string” minOccurs=“1”/>

<xs:element name=“resources”

type=“resourceType” minOccurs=“1”/>

<xs:element name=“trustLevel”

type=“xs:string”/>

<xs:element name=“performance”

type=“performanceType” minOccurs=“0”/>

<xs:element

name=“compositionRules” type=“compositionRuleType”
minOccurs=“0”/>

</xs:sequence>
<xs:attribute name=“serviceID”

type=“xs:string”/>

</xs:complexType>

</xs:element>

</xs:sequence>

</xs:complexType>
<xs:complexType name =“resourceType”>

<xs:sequence>

<xs:element name=“resourceClaim”

maxOccurs=“unbounded”>

<xs:complexType>

<xs:sequence>

<xs:element name =“resourceName”

type=“xs:string” minOccurs=“1”/>

<xs:element name=“consumptionReq”

type=“xs:string” minOccurs=“1”/>

</xs:sequence>

</xs:complexType>

</xs:element>

</xs:sequence>

</xs:complexType>
<xs:complexType name=“performanceType”>

<xs:sequence>

<xs:element name= “performanceClaim”

maxOccurs=“unbounded”>

<xs:complexType>

<xs:sequence>

<xs: element name=“attribute”

type=“xs:string” minOccurs=“1”/>

<xs:element name=“value”

type=“xs:string” minOccurs=“1”/>

</xs:sequence>

</xs:complexType>

</xs:element>

</xs:sequence>

</xs:complexType>
<xs:complexType name=“compositionRuleType”>

<xs:sequence>

<xs:element name=“compositionRuleClaim”

maxOccurs=“unbounded”>

<xs:complexType>

<xs:sequence>

<xs:element

name=“compositionItemName” type=“xs:string”
minOccurs=“1”/>

<xs:element name=“policy”

type=“xs:string” minOccurs=“1”/>

</xs:sequence>
</xs:complexType>

</xs:element>

</xs:sequence>

</xs:complexType>

</xs:schema>

Said component profile may be bound together with a software certificate and/or permission profile, thus the invention is compatible with existing trust/security verification technology. For instance, a new profile may comprise both the security verification and said component profile indicating specifications.

FIG. 1b depicts a schematic flow chart illustrating a second exemplary method according to the present invention, which is based on the first exemplary method shown in FIG. 1a and explained above, wherein at least one component profile, e.g. the component profile depicted in FIG. 4 and explained above, is used to extract at least one service specification from at least one service profile 420 into said set of specifications and/or to compose at least one service specification with at least one further service specification into at least one composed specification associated with said set of specifications (step 105).

For instance, only service specifications of at least one service of said software component may be extracted, and/or any kind of composing of at least one service specification of at least one service of said software component with at least one service specification of at least one further service of said software component and/or with at least one service specification of at least one service of at least one other software component into at least one composed specification may be performed.

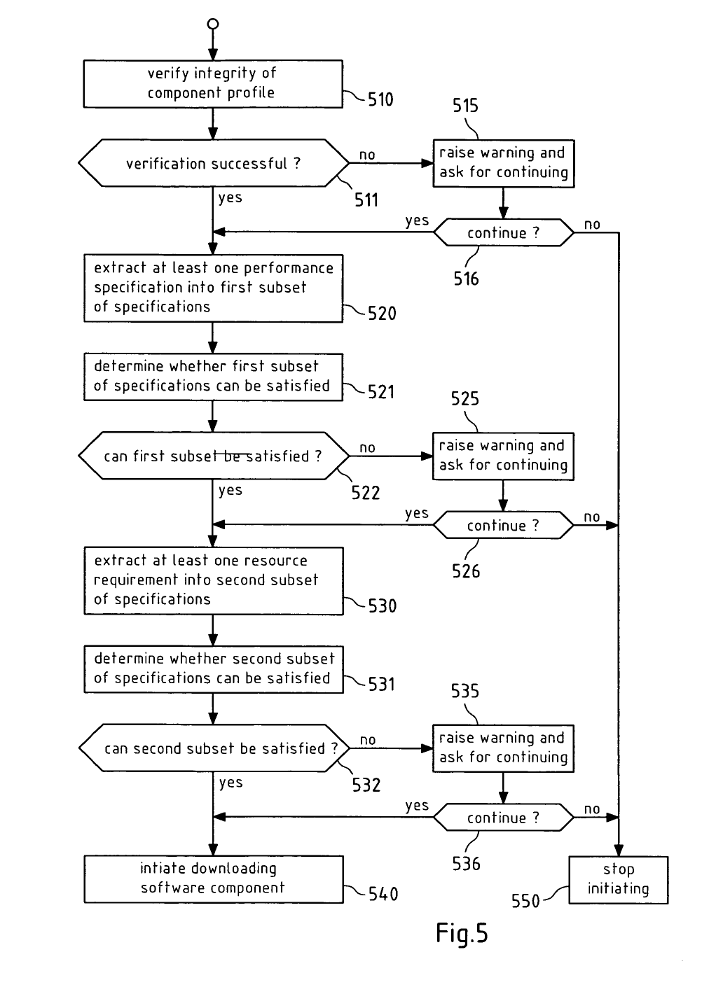

FIG. 5 depicts a schematic flow chart illustrating a third exemplary method according to the present invention.

In this third exemplary method, said function to be initiated is downloading the software component into the system, and thus this third exemplary method may be used to perform a trustworthiness prediction for a software component download.

The software component to be downloaded is assumed to be associated with a component profile, e.g. a component profile according to the exemplarily component profile depicted in FIG. 4 and described above.

At first, the integrity of the component profile may be verified (step 510), and if verification is detected to be successful (step 511), then it is proceeded with determining whether a set of specifications related to a software component can be satisfied by a system according to the present invention. Otherwise, if verification is not successful, then a warning may be raised and a user may be asked for deciding whether to continue with determining whether a set of specifications related to a software component can be satisfied by a system or not (step 515). Depending on the user's decision, determining whether a set of specifications related to a software component can be satisfied by a system is continued or not (step 516). This integrity verification is only optional, i.e. the second exemplary method may also start with extracting at least one performance specification (step 520).

In this third exemplary method the set of specifications comprises a first subset of specifications and a second subset of specifications, but the number of subsets may vary from one subset to any plurality of subsets. For each subset it is determined whether the specifications in said subset can be satisfied, respectively.

At least one performance specification 424, 440 of at least one service 415 of the software component is extracted from the service profile 420 from the component profile 410 of said software component into the first subset of specifications (step 520).

Then, it is determined whether said at least one performance specification in said first subset of specifications can be satisfied (step 521), and if said first subset can be satisfied, then it is proceeded with determining the trustworthiness of the second subset of specifications (steps 530, 531, 532). Otherwise a warning may be raised and a user may be asked for deciding whether to continue or not (step 525), and depending on the user's decision (step 526), the method proceeds with determining the trustworthiness of the second subset of specifications (steps 530, 531, 532) or stops initiating the download function (step 550).

Thus, before said software component is downloaded into said system, the system can check the performance offered by said software component, wherein the performance specification of one service, of a variety of services or of all services may be verified.

If said first subset of specifications can be fulfilled (step 522) or if the user decides to proceed with the method (step 526) then at least one resource requirement 422, 430 of at least one service 515 if the software component is extracted from the service profile 420 from the component profile 410 of said software component into the second subset of specifications (step 530).

Then, it is determined whether said at least one resource requirement in said second subset of specifications can be satisfied (step 531), and if said second subset can be satisfied, then it is proceeded with initiating the download of said software component (step 540). Otherwise a warning may be raised and a user may be asked for deciding whether to continue or not (step 535), and depending on the user's decision (step 536), the method proceeds with initiating the download of said software component (step 540) or stop initiating the download (step 550).

Thus, before said software component is downloaded into said system, it can be verified whether the system provides resources of said software component, wherein the resource requirement of one service, of a variety of services or of all services may be verified.

Thus, at first, performance specifications are verified associated with the first subset of specifications, and then resource requirements are verified associated with the second subset of specifications. Alternatively, the second subset of specifications may be verified first followed by the first subset of specifications.

According to the present invention, the trust for a component download may be predicted, e.g. by use of the second exemplary method depicted in FIG. 5 or by use of the first exemplary method in FIG. 1a or use of the second exemplary method in FIG. 1b, and thus potential trust influence can be predicted before a software component is downloaded into the system.

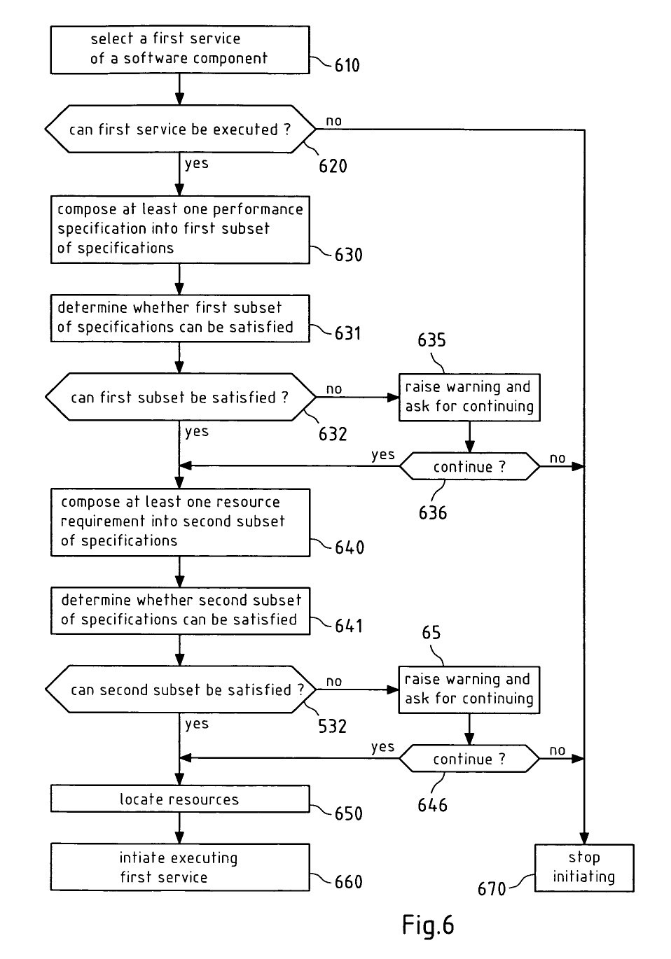

FIG. 6 depicts a schematic flow chart illustrating a fourth exemplary method according to the present invention.

In this fourth exemplary method, said function to be initiated is executing a service of a software component by the system, and thus this fourth exemplary method may be used to perform a trustworthiness prediction for a software component execution.

The software component to be executed is assumed to be associated with a component profile, e.g. a component profile according to the exemplarily component profile depicted in FIG. 4 and described above.

A first service of at least one service of a software component may be selected (step 610), wherein this first service is selected to be executed on the system. Thus, the software component including said first service may be already loaded into the system, e.g. by the second exemplary method depicted in FIG. 5 or by the first exemplary method depicted in FIG. 1.

It is assumed, that at least one further service is running on the system and/or is at least one further service of said software component different from said first service. Then (not shown in FIG. 6), the service profiles of said at least on further service may be extracted, and the service profile of said first profile may be extracted.

Then it may be checked whether the first service is executable in the system (step 620), e.g. based on the service description 421 from the extracted service profile, and if the first service can not be executed, then initiating the execution of said first service might be stopped (670).

In this forth exemplary method the set of specifications comprises a first subset of specifications and a second subset of specifications, but the number of subsets may vary from one subset to any plurality of subsets. For each subset it is determined whether the specifications of said subset can be satisfied, respectively.

Based on the service profiles, at least one performance specification 424, 440 of said first service is composed with at least one performance specification 424, 440 of at least one service of at least one further software component running on said system and/or at least one performance specification 424, 440 of at least one further service of said software component into at least one composed performance specification, wherein said at least one composed performance specification is associated with said first subset of specifications (step 630).

For instance, at least one composition rule 425 of a service profile 420 of said first service may be used to compose said at least one composed resource requirement, wherein said composing may further be based on at least one composition rule 425 of said at least one service of said at least one further software component and/or on at least one composition rule 425 of said at least one further service of said software component, and wherein said composing may further be based on a service description 421 of said first service and/or on at least one service description 421 of said at least one service of said at least one further component and/or on at least one service description 421 of said at least one further service of said software component.

Then, it is determined whether said at least one composed performance specification in said first subset of specifications can be satisfied (step 631), and if said first subset can be satisfied, then it is proceeded with determining the trustworthiness of the second subset of specifications (steps 640, 641, 642). Otherwise a warning may be raised and a user may be asked for deciding whether to continue or not (step 635), and depending on the user's decision (step 636), it may be proceeded with determining the trustworthiness of the second subset of specifications (steps 640, 641, 642) or by stopping to initiate the execution function (step 670). Thus, before said first service is executed by said system, it can be verified whether said first service's performance can satisfy the system's or the user's performance expectation by incorporating the performance specifications of services running on the system and/or performance specifications of other services in said software component.

If said first subset of specifications can be fulfilled (step 632) or if the user decides to proceed (step 636), then at least one resource requirement 422, 430 of said first service is composed with at least one resource requirement 422, 430 of at least one service of at least one further software component running on said system into at least one composed resource requirement and/or with at least one resource requirement 422, 430 of at least one further service of said software component, wherein said at least one composed resource requirement is associated with said second subset of specifications (step 640).

This composing may be based on the service profiles of said services, wherein, for instance, at least one composition rule 425 of a service profile 420 of said first service may be used to compose said at least one composed performance specification, wherein said composing may further be based on at least one composition rule 425 of said at least one service of said at least one further software component and/or on at least one composition rule 425 of said at least one further service of said software component, and wherein said composing may further be based on a service description 421 of said first service and/or on at least one service description 421 of said at least one service of said at least one further component and/or on at least one service description 421 of said at least one further service of said software component.

Then, it is determined whether said at least one resource requirement in said second subset of specifications can be satisfied (step 641), and if said second subset can be satisfied, then it is proceeded with initiating the execution of said software component (step 660). Otherwise a warning may be raised and a user may be asked for deciding whether to continue or not (step 645), and depending on the user's decision (step 646), it is proceeded with initiating the execution of said software component (step 660) or stopping said initiating the execution (step 670).

Thus, before said first service is executed by said system, it can be verified whether the system provides resources for said first service by incorporating the resource requirements of services running on the system.

Before said first service is executed (step 660), resources may be arranged to said first service and to at least one service running on the system (step 650), e.g. based on trust level specifications 423.

Furthermore, a service profile 420 of any service 415 may be adaptable, so that for instance resource requirements 422, 430 and/or performance specifications 424, 440 and/or trust level specifications can be adjusted, e.g. based on the system's real execution results. Thus, an improved resource, performance and/or trust management of the system can be achieved.

Thus, at first, composed performance specifications are verified associated with the first subset of specifications, and then composed resource requirements are verified associated with the second subset of specifications. Alternatively, the second subset of specifications may be verified first followed by the first subset of specifications.

According to the present invention, the trust for a software component execution, e.g. the execution of a service of said software component, may be predicted, e.g. by use of the third exemplary method depicted in FIG. 6 or by use of the first exemplary method in FIG. 1a or by use of the second exemplary method in FIG. 1b, and thus potential trust influence can be predicted before a software component is executed by the system.

Furthermore, the set of specifications in said first, second, third and fourth exemplary methods is not limited to resource requirements and performance specifications, also trust level specifications or any other specifications related to a software component and/or a service of a software component may be associated with said set of specifications in order to verify if the system can satisfy these specifications.

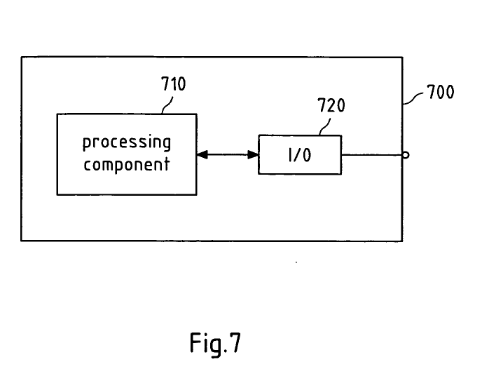

FIG. 7 depicts a schematic block diagram of an apparatus according to the present invention, wherein the apparatus comprises a processing component 710 configured to determine whether a set of specifications related to a software component can be satisfied by a system, wherein said set of specifications comprises at least one specification, and wherein at least one specification of said at least one specification is one out of a resource requirement and a performance specification; and to initiate a function provided by the system when said set of specifications can be satisfied, wherein said function is related to said software component. Furthermore, said apparatus may comprise an interface 720 for connecting said processing component to a system, e.g. the system depicted in FIG. 3. For instance, said apparatus may be a trust management chip.

Thus, according to the present invention, a trustworthiness prediction about the software component in said system can be performed before a function related to said software component is initiated, and depending on said trustworthiness prediction, said function related to said software component is initiated, wherein said function may be downloading said software component and/or executing said software component, e.g. executing a service of said software component, or any further function related to a software component. Hence, the method allows improving predictability on potential trust conflicts on non-functional properties such as resource availability and/or system reliability.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures.

1. A method comprising:
determining whether a set of specifications related to a software component can be satisfied by a system, wherein said set of specifications comprises at least one specification, and wherein at least one specification of said at least one specification is one out of a resource requirement and a performance specification; and
initiating a function provided by the system if said set of specifications can be satisfied, wherein said function is related to said software component.

2. The method according to claim 1, wherein in case that at least one of said at least one specification can not be satisfied by the system said method further comprises:
raising a warning; and
initiating or not initiating said function provided by the system depending on a user's decision.

3. The method according to claim 1, wherein said function represents one of:
downloading said software component into said system; and
executing said software component by said system.

4. The method according to claim 1, wherein said software component is associated with a component profile indicating specifications suited to be used to determine said set of specifications.

5. The method according to claim 4, wherein said software component contains at least one service, and wherein said profile comprises a service profile for at least one of said at least one service, respectively, said service profile comprising at least one service specification of said service, wherein at least one of said at least one service specification is at least one out of:
at least one resource requirement;
at least one performance specification;
and at least one trust level specification.

6. The method according to claim 5, wherein said method further comprises locating resources for at least one service in said system based on at least one trust level specification in at least one service profile.

7. The method according to claim 5, wherein said service profile comprises at least one composition rule for composing at least one service specification of said service profile with at least one corresponding service specification of at least one different service, and wherein said method further comprises:
composing at least one service specification of at least one of said at least one service profile of said software component with at least one further service specification into at least one composed specification associated with said set of specifications.

8. The method according to claim 5, said method further comprising:
extracting at least one service specification from at least one of said at least one service profile of said software component into said set of specifications.

9. The method according to claim 8, wherein said function is downloading said software component into said system, and wherein said set of specifications comprises a first subset of specifications, wherein said first subset of specifications comprises at least one performance specification of at least one service of said software component extracted from said at least one service profile.

10. The method according to claim 9, wherein said set of specifications comprises a second subset of specifications, wherein said second subset of specifications comprises at least one resource requirement of at least one service of said software component extracted from said at least one service profile.

11. The method according to claim 9, wherein said set of specifications comprises a second subset of specifications, said method further comprising:
composing at least one resource requirement of at least one of said at least one service profile of said software component with at least one resource requirement of at least one service of said software component and/or with at least one resource requirement of at least one service of at least one further software component running on said system into at least one composed resource requirement associated with said second subset of specifications.

12. The method according to claim 7, wherein said function represents executing a first service of said software component in said system, and wherein said set of specifications comprises a first subset of specifications, wherein said composing comprises:
composing at least one performance specification of said first service with at least one performance specification of at least one further service of said software component and/or with at least one performance specification of at least one service of at least one further software component running on said system into at least one composed performance specification associated with said first subset of specifications.

13. The method according to claim 12, wherein said set of specifications comprises a second subset of specifications, said method further comprising:
composing at least one resource requirement of said first service with at least one resource requirement of at least one further service of said software component and/or with at least one resource requirement of at least one service of at least one further software component running on said system into at least one composed resource requirement associated with said second subset of specifications.

14. The method according to claim 12, said method further comprising:
composing at least one trust level specification of said first service with at least one trust level specification of at least one further service of said software component and/or with at least one trust level specification of at least one service of at least one further software component running on said system into at least one composed trust level specification associated with said set of specifications.

15. The method according to claim 12, said method further comprising, prior to said determining whether said set of specifications of said software component can be satisfied, verifying whether said first service can be executed on said system based on the service description of said service, and stop performing said first service when said first service can not be executed.

16. The method according to claim 5, wherein at least one of said at least one service specification of at least one service profile can be updated.

17. An apparatus comprising:
a processing component configured to:
determine whether a set of specifications related to a software component can be satisfied by a system, wherein said set of specifications comprises at least one specification, and wherein at least one specification of said at least one specification is one out of a resource requirement and a performance specification; and to initiate a function provided by the system if said set of specifications can be satisfied, wherein said function is related to said software component.

18. The apparatus according to claim 17, wherein in case that at least one of said at least one specification can not be satisfied by the system a warning is raised, and, depending on a user's decision, said function provided by the system is initiated or not initiated.

19. The apparatus according to claim 17, wherein said function represents one of:
downloading said software component into said system; and
executing said software component by said system.

20. The apparatus according to claim 17, wherein said software component is associated with a component profile indicating specifications suited to be used to determine said set of specifications.

21. The apparatus according to claim 20, wherein said software component contains at least one service, and wherein said profile comprises a service profile for at least one of said at least one service, respectively, said service profile comprising at least one service specification of said service, wherein at least one of said at least one service specification is at least one out of
at least one resource requirement;
at least one performance specification; and
at least one trust level specification.

22. The apparatus according to claim 21, wherein said processing component is further configured to:
Locating resources for at least one service in said system based on at least one trust level specification in at least on service profile.

23. The apparatus according to claim 21, wherein said service profile comprises at least one composition rule for composing at least one service specification of said service profile with at least one corresponding service specification of at least one different service, and wherein said processing component is further configured to:
composing at least one service specification of at least one of said at least one service profile of said software component with at least on further service specification into at least one composed specification associated with said set of specifications

24. The apparatus according to claim 22, wherein said processing component is further configured to:
extracting at least one service specification from at least one of said at least one service profile of said software component into said set of specifications.

25. The apparatus according to claim 24, wherein said function is downloading said software component into said system, and wherein said set of specifications comprises a first subset of specifications, wherein said first subset of specifications comprises at least one performance specification of at least one service of said software component extracted from said at least one service profile.

26. The apparatus according to claim 25, wherein said set of specifications comprises a second subset of specifications, wherein said second subset of specifications comprises at least one resource requirement of at least one service of said software component extracted from said at least one service profile.

27. The apparatus according to claim 25, wherein said set of specifications comprises a second subset of specifications, and wherein said processing component is further configured to compose at least one resource requirement of at least one of said at least one service profile of said software component with at least one resource requirement of at least one service of said software component and/or with at least one resource requirement of at least one service of at least one further software component running on said system into at least one composed resource requirement associated with said second subset of specifications.

28. The apparatus according to claim 23, wherein said function represents executing a first service of said software component in said system, and wherein said set of specifications comprises a first subset of specifications, wherein said processing component is further configured to:
compose at least one performance specification of said first service with at least one performance specification of at least one further service of said software component and/or with at least one performance specification of at least one service of at least one further software component running on said system into at least one composed performance specification associated with said first subset of specifications.

29. The apparatus according to claim 28, wherein said set of specifications comprises a second subset of specifications, wherein said processor component is further configured to:
compose at least one resource requirement of said first service with at least one resource requirement of at least one further service of said software component and/or with at least one service of at least one further software component running on said system into at least one composed resource requirement associated with said second subset of specifications.

30. The apparatus according to claim 28, wherein said processing component is further configured to:
compose at least one trust level specification of said first service with at least one trust level specification of at least one further service of said software component and/or with at least one trust level specification of at least one service of at least one further software component running on said system into at least one composed trust level specification associated with said set of specifications.

31. The apparatus according to claim 28, wherein said processing component is further configured to, prior to said determining whether said set of specifications of said software component can be satisfied, verify whether said first service can be executed on said system based on the service description of said service, and stop performing said first service when said first service can not be executed.

32. The apparatus according to claim 20, wherein said processing component is further configured to update at least one of said at least one service specification of at least one service profile.

33. A system comprising an apparatus according to claim 17, wherein said system is configured to perform said function related to said software component.

34. A computer program product in which a program code is stored in a computer readable medium, said program code realizing the method of claim 1 when executed by a processor.

35. An apparatus comprising:
means for determining whether a set of specifications related a software component can be satisfied by a system, wherein said set of specifications comprises at least one specification, and wherein at least one specification of said at least one specification is one out of a resource requirement and a performance specification; and means for initiating a function provided by the system if said set of specifications can be satisfied, wherein said function is related to said software component.
